(19) United States
(12) Patent Application Publication
(10) Pub. No.: US 2011/0037740 A1
(43) Pub. Date: Feb. 17, 2011

(54) PLANAR ILLUMINATION DEVICE AND LIQUID CRYSTAL DISPLAY

(75) Inventor: Hiroshi Yamaguchi, Osaka (JP)

Correspondence Address: HAMRE, SCHUMANN, MUELLER & LARSON P.C., P.O. BOX 2902, MINNEAPOLIS, MN, 55402-0902, US

(73) Assignee: PANASONIC CORPORATION, Kadoma-shi, Osaka (JP)

(21) Appl. No.: 12/989,320

(22) PCT Filed: Dec. 15, 2009
(86) PCT No.: PCT/JP2009/006896

§ 371 Date: Oct. 22, 2010

(30) Foreign Application Priority Data
Dec. 15, 2008 (JP) 2008-317938

(51) Int. Cl. G09G 5/00; F21V 8/00; G09G 3/36

(52) U.S. Cl. 345/204; 362/558; 362/555; 345/87

(57) ABSTRACT

A planar illumination device (100) is provided with a plurality of light sources (2) provided on a same plane, a light guide plate (5) having a plurality of accommodating holes (50) accommodating the light sources (2) separately, and a diffusion plate (6) provided facing a light exit surface (5a) of the light guide plate (5). Each of the plurality of accommodating holes (50) has a shape corresponding to a shape of each of the plurality of light sources (2) such that a light flux angular density of the light transmitted through the internal surface of the accommodating hole, in an angular direction around the center of the light source (2) accommodated in the accommodating hole (50) as viewed from a direction orthogonal to the plane, increases toward each vertex of a unit section that surrounds the light source (2) in the light guide plate (5).

### TECHNICAL FIELD

The present invention relates to a planar illumination device and a liquid crystal display apparatus using the planar illumination device as a backlight.

### BACKGROUND ART

Thin and lightweight liquid crystal display apparatuses capable of displaying images have spread rapidly due to the development of image enhancement technology and the price reduction resulting from the progress of production technology, and are now widely used as a monitor for personal computers, a TV receiver or the like.

Transmissive liquid crystal display apparatuses are used generally as a liquid crystal display apparatus. Such a transmissive liquid crystal display apparatus is provided with a planar illumination device called a backlight, and forms images by spatially modulating illumination light from the planar illumination device with a liquid crystal panel.

The backlight system mainly is represented by: an edge light type that uses a light guide plate with light sources being provided on its edge surfaces and allows light to exit from one main surface of the light guide plate (for example, Patent Literature 1); and a direct type that performs illumination by providing light sources immediately below a liquid crystal panel (for example, Patent Literature 2).

In both cases, fluorescent tubes were used conventionally as light sources in common. However, LEDs, for which remarkable progress has been made in technologies for efficiency enhancement and price reduction, are now increasingly used in recent years.

The edge light type is formed by providing optical films such as a prism sheet and a diffusion sheet further on the side of the light exit surface that allows the light from the light guide plate to exit. The edge light type can achieve a reduction in thickness and therefore is used mainly in a liquid crystal display apparatus with a relatively small screen, such as a cellular phone.

Meanwhile, the direct type is formed by providing a diffusion plate and optical films such as a prism sheet and a diffusion film between the liquid crystal panel and the light sources, and is used mainly in a liquid crystal display apparatus with a large screen, such as a liquid crystal television. In particular, in the case of using LEDs, each of which is a point light source, as a light source, it is possible to illuminate only a specific section by arranging LEDs on lattice points (in matrix). This enables local area control in which the illumination intensity of each point can be controlled in synchronization with image signals. Thus, it is expected that this illumination system can achieve high contrast between light and dark areas and power saving in a liquid crystal television.

However, the edge light type in which the light sources are provided on the edge surfaces of the light guide plate cannot be applied to a large screen, which is a problem. Specifically, the required amount of light quadratically increases with the area corresponding to the diagonal screen size, whereas the length of the side surfaces on which light sources can be provided increases linearly. Therefore, the larger the screen, the more the required light flux density increases, which makes it difficult to locate light sources. Furthermore, the heat generation density also increases, so that heat dissipation is rendered difficult. Because of this problem, the diagonal screen size that currently is put to practical use as the edge light type is limited to about 20 inch. Although this problem can be eased if the luminescence efficiency of light sources is improved, there still remains the problem of difficulty in achieving high contrast and power saving to be brought about by the aforementioned local area control in the edge light type.

On the other hand, in the direct type, the area to be provided with light sources increases in proportion to the screen area. Therefore, the above-mentioned problems of locating light sources and dissipating heat do not occur in use for a large screen. Further, it additionally has the advantage of the ability to perform local area control. However, in order to achieve uniform illumination by light from light sources that are discretely arranged, a given interval is required from the light sources to the diffusion plate. That is the reason for the thickness reduction being limited in the display apparatus. For example, in the case of using LEDs as light sources and arranging them at a pitch of 30 mm, the interval from the LEDs to the diffusion plate is required to be nearly equal to the pitch, that is, about 30 mm. This problem can be eased by decreasing the arrangement pitch of the LEDs. However, as the arrangement pitch is decreased, the required number of light sources increases in inverse proportion to the square of the pitch. For example, when the diagonal screen size is 37 inch and the pitch is 30 mm, the required number of LEDs is 405 (15 in length×27 in width). On the other hand, when the pitch is 10 mm, the required number of LEDs is 3726 (46 in length×81 in width), which is approximately 9 times the former. When a number of LEDs are used as in the above case, the cost of light sources and the cost of drive circuits increase, thereby causing an increase in price of the apparatus.

Recently, there is further proposed a planar illumination device that has the advantageous effects of both the edge light type and the direct type, in which thickness reduction and local area control can be achieved. For example, Patent Literature 3 discloses a planar illumination device 9 as shown in FIGS. 14A and 14B. This planar illumination device 9 includes a light guide plate 92 provided with a plurality of circular through holes 92a arranged in a staggered manner, and a light source 91 that has a circular shape as viewed in plan and fitted into each of the through holes 92a. The light source 91 serves to radiate light radially to the surroundings. The light radiated from the light source 91 enters the inside of the light guide plate 92 through the internal surface of the through hole 92a, and thereafter exits from one main surface of the light guide plate 92.

### CITATION LIST

Patent Literature 1: JP 1997-034371 A

Patent Literature 2: JP 2005-249942 A

Patent Literature 3: US 2008/0186273 A1

### SUMMARY OF INVENTION

### Technical Problem

However, when the light source 91 and the through hole 92a both are circular as shown in FIG. 14A, light uniformly radiated from the light source 91 to the surroundings is transmitted through the internal surface of the through hole 92a almost without changing its direction to enter the inside of the light guide plate 92. Therefore, the amount of light is insufficient at portions away from the light source 91 (for example, the position of the centroid of a triangle, the vertices of which are defined by three light sources 91), thus causing unevenness in brightness.

In view of such circumstances, it is an object of the present invention to provide a planar illumination device capable of reducing the in-plane unevenness in brightness and a liquid crystal display apparatus using the planar illumination device as a backlight.

### Solution to Problem

In order to solve the above-mentioned problem, the planar illumination device of the present invention includes: a plurality of light sources that are provided on the same plane and capable of radiating light radially in a direction parallel to the plane; a light guide plate that has a plurality of accommodating holes accommodating the plurality of light sources separately and allows the light that has been radiated from the plurality of light sources and has entered the inside of the light guide plate through the internal surfaces of the plurality of accommodating holes to exit from a light exit surface that is one main surface of the light guide plate; and a diffusion plate provided facing the light exit surface of the light guide plate. Each of the plurality of accommodating holes has a shape corresponding to the shape of each of the plurality of light sources such that the light flux angular density of the light that has been transmitted through the internal surface of the accommodating hole in an angular direction, as viewed from a direction orthogonal to the plane, around the center of the light source accommodated in the accommodating hole increases toward each vertex of a unit section that surrounds the light source in the light guide plate.

It should be noted that the above-mentioned unit section is a section defined by a line composed of a sequence of points each having a distance from one light source equal to a distance from another light source adjacent thereto.

Further, the liquid crystal display apparatus of the present invention includes: the above-mentioned planar illumination device; and a liquid crystal panel that is provided on the light exit side of the planar illumination device and displays images by spatially modulating light from the planar illumination device in response to image signals.

### ADVANTAGEOUS EFFECTS OF INVENTION

The planar illumination device of the present invention allows light from the light source to converge relatively more in directions toward each vertex of the unit section because the accommodating hole has a shape corresponding to the shape of the light source. Therefore, the in-plane unevenness in brightness can be reduced. Further, the liquid crystal display apparatus of the present invention using this planar illumination device makes it possible to display images of excellent contrast and high quality.

### BRIEF DESCRIPTION OF DRAWINGS

FIG. 1 is a perspective view showing the schematic configuration of a planar illumination device according to Embodiment 1.

FIG. 2 is a partial sectional view showing the schematic configuration of the planar illumination device according to Embodiment 1.

FIG. 3 is a plan view showing unit sections of a light guide plate in Embodiment 1.

FIG. 4 is an enlarged view of the main part of FIG. 3.

FIG. 5A is a view showing a pattern of output portions, and FIG. 5B is a view showing contour lines each having an equal concentration.

FIG. 6A is a plan view showing a light source and an accommodating hole of Embodiment 1, FIG. 6B is a plan view showing a light source and an accommodating hole of a comparative embodiment, and FIG. 6C is a plan view showing a light source and an accommodating hole of another embodiment.

FIG. 7 is a graph showing the relationship between θ and dφ/dθ, and the relationship between θ and (L(θ)/L₀)².

FIG. 8 is a partial sectional view showing the configuration of another planar illumination device.

FIG. 9 is a sectional view showing the configuration of another light source.

FIG. 10 is a perspective view showing the configuration of still another planar illumination device.

FIG. 11 is a plan view showing an accommodating hole of a modified embodiment.

FIG. 12 is a plan view showing the unit sections of the light guide plate in the case where the light sources are arranged in a staggered manner.

FIG. 13 is a block diagram showing the configuration of a liquid crystal display apparatus according to Embodiment 2.

FIG. 14A is a plan view showing a conventional planar illumination device, and FIG. 14B is a sectional view showing the planar illumination device.

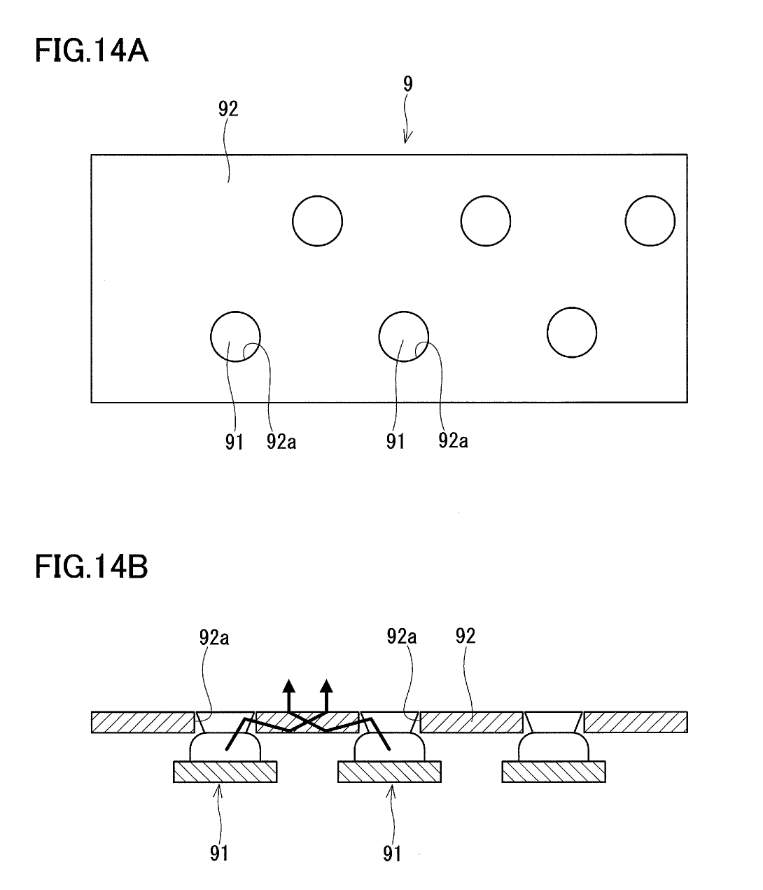

### DESCRIPTION OF EMBODIMENTS

Hereinafter, the embodiments of the present invention are described with reference to the drawings.

### Embodiment 1

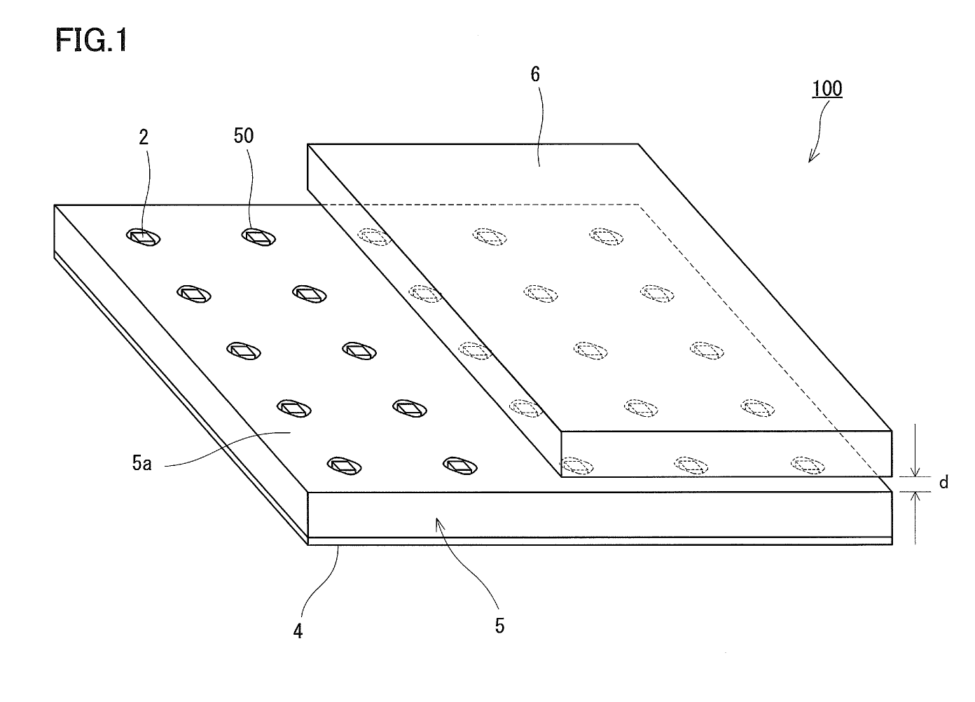

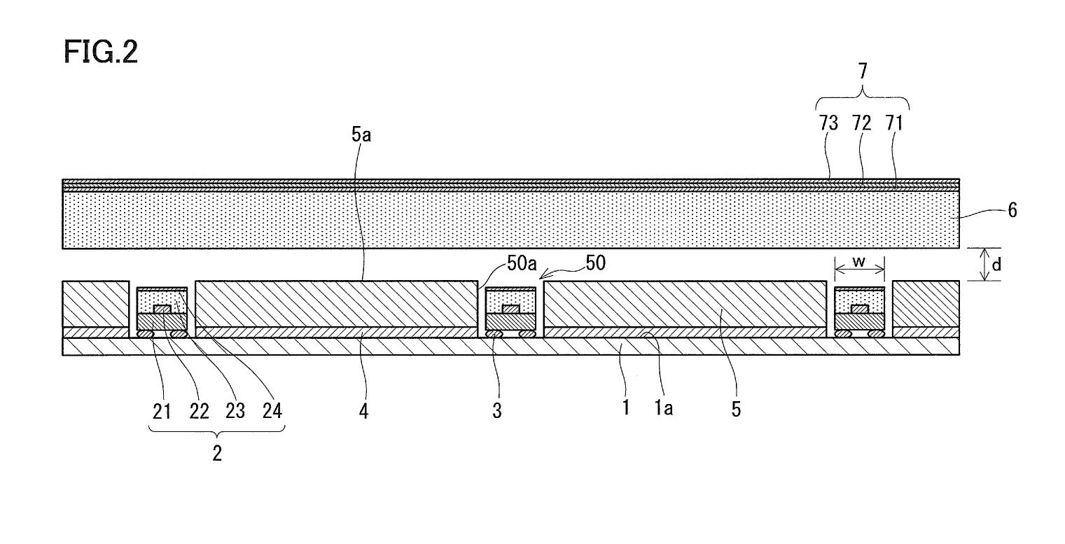

FIG. 1 is a perspective view showing the schematic configuration of a planar illumination device 100 according to Embodiment 1 of the present invention. FIG. 2 is a partial sectional view showing the schematic configuration of the planar illumination device 100. It should be noted that, in FIG. 1, the illustration of the left side of a diffusion plate 6 is cut off and the illustrations of optical sheets 7 and a mounting substrate 1 that are shown in FIG. 2 are omitted so that the main part can be viewed easily.

The planar illumination device 100 includes the mounting substrate 1, a plurality of light sources 2 each mounted on a mounting surface 1a of the mounting substrate 1 with a solder bump 3, a reflective sheet 4 that covers the mounting surface 1a of the mounting substrate 1 without interfering with the light sources 2, and a light guide plate 5 between which and the mounting substrate 1 the reflective sheet 4 is interposed. Further, the diffusion plate 6 is provided facing a light exit surface 5a that is one main surface of the light guide plate 5, and the optical sheets 7 are stacked on a main surface of the diffusion plate 6 on the opposite side of the light guide plate 5.

The light sources 2 are provided on the same plane (that is, the mounting surface 1a of the mounting substrate 1), and radiate light radially in a direction parallel to the mounting surface 1a. The light sources 2 preferably are arranged in two different directions at the same pitch. In this embodiment, the light sources 2 are arrayed in two directions orthogonal to each other, and arranged on lattice points.

Specifically, each of the light sources 2 includes a substrate 21, an LED element 22 mounted on the substrate 21, a resin portion 23 that is made of transparent resin and encapsulates the LED element 22, and a reflector 24 provided on the opposite side of the substrate 21 with respect to the resin portion 23, as shown in FIG. 2. In this embodiment, the resin portion 23 has a quadrangular prism shape, and the reflector 24 is attached to the top surface of the resin portion 23 on the opposite side of the substrate 21.

The LED element 22 of this embodiment emits blue light, and fluorescent material that converts blue light into yellow light is dispersed in the resin portion 23. The resin portion 23 transmits part of blue light from the LED element 22 and converts the rest of the blue light into yellow light, thereby producing white light.

Among the above-mentioned white light, the light that has reached the top surface of the resin portion 23 is reflected by the reflector 24. Eventually, all the white light is radiated from the side surface of the resin portion 23 laterally over the entire circumference thereof, and enters the light guide plate 5, as will be described later. Examples of the reflector 24 to be used include diffuse reflectors such as a white PET sheet that contains a number of micropores therein, a white alumina substrate, and a white plate that has a transparent substrate printed with white pigment, and a specular reflector that has a transparent substrate on the surface of which a reflective film made of metals such as silver and aluminium is formed.

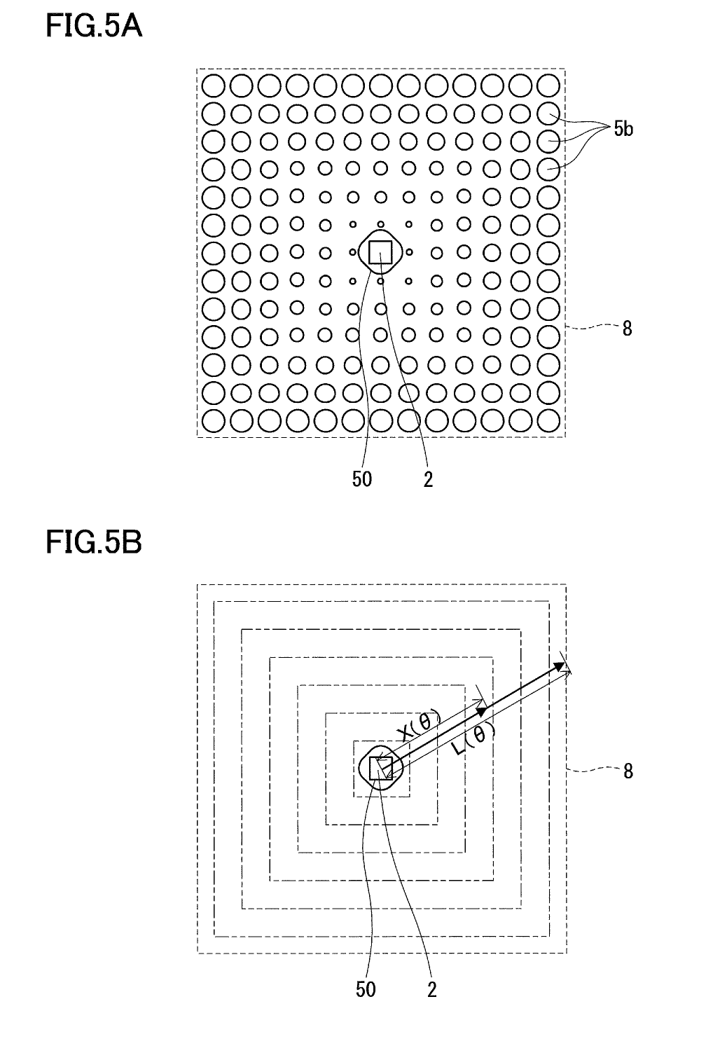

The light guide plate 5 in a substantially flat plate shape has a plurality of accommodating holes 50 that accommodate the light sources 2 separately. The internal surface of each of the accommodating holes 50 forms an incident surface 50a that allows light radiated from the light source 2 to enter the inside of the light guide plate 5. The light that has entered the inside of the light guide plate 5 through the incident surface 50a travels while repeating total reflection on main surfaces of the light guide plate 5 that face each other. The other main surface of the light guide plate 5 on the opposite side of the light exit surface 5a is partially provided with a plurality of output portions 5b (see FIG. 5A) that reflect the light that has reached the other main surface so as to allow the light to be transmitted through the light exit surface 5a. The output portions 5b are, for example, white dots formed by printing or a three-dimensional structure integratedly formed with the light guide plate 5. Light travelling in the light guide plate 5 is deviated from total reflection conditions by being reflected on the output portions 5b when it is incident on the output portions 5b, and exits from the light exit surface 5a. By appropriately setting the size or density of the output portions 5b (that is, patterning the output portions a), the light can exit almost uniformly from the entire light exit surface 5a. However, the light does not exit from directly above the light source 2 due to the presence of the reflector 24.

The diffusion plate 6 that faces the light exit surface 5a of the light guide plate 5 is a resin plate with a thickness of about 1 to 3 mm that uses a transparent resin material, such as acrylic and polycarbonate, as a base material and that contains fine particles with a different refractive index from that of the base material dispersed therein. The light that has exited from the light exit surface 5a of the light guide plate 5 enters the diffusion plate 6. Part of the light that has entered the diffusion plate 6 is transmitted through the diffusion plate 6 while being diffused, whereas the other part thereof is reflected to be returned to the side of the light guide plate 5. The diffusion plate 6 has a relatively large thickness. Therefore, the light transmitted through the diffusion plate 6 is allowed to have a component to travel laterally within the diffusion plate 6, which reduces the unevenness caused by dark portions that appear directly above the light sources 2. Further, the light reflected on the diffusion plate 6 is transmitted through the light guide plate 5, thereafter reflected on the reflective sheet 4, and transmitted through the light guide plate 5 again. Finally, it enters the diffusion plate 6 again. The diffusion plate 6 is irradiated almost uniformly with this re-incident reflection component, which thus contributes to the improvement of the unevenness.

The transmission and reflection properties of the diffusion plate 6 as mentioned above can be adjusted by the refractive index of the fine particles to be dispersed therein (the difference in the refractive index from the base material), the particle size and the content mixing ratio thereof. The higher the reflectance of the diffusion plate 6, the more the ratio of primarily exiting light decreases and the re-incident reflection component increases, which is more effective for reducing the unevenness. However, the reflectance of the reflective sheet 4 is not 100% and therefore light loss occurs. Thus, the efficiency is decreased. Further, excessively high reflectance impairs the aforementioned lateral travelling effect in the diffusion plate 6. In view of these, the transmittance of the diffusion plate 6 is preferably about 40% to 70%.

The optical sheets 7 stacked on the main surface of the diffusion plate 6 on the opposite side of the light guide plate 5 include a diffusion film 71, a prism sheet 72, and a polarization reflection film 73. The diffusion film 71 is provided to support the function of the diffusion plate 6. The prism sheet 72 has functions of reflecting perpendicularly incident light toward the diffusion plate 6, as well as providing a directivity to the light transmitted therethrough so as to enhance the front brightness. The polarization reflection sheet 73 transmits only the polarized component transmitted through the polarization plate on the incident side of a liquid crystal panel (not shown) that is provided on the light exit side of the planar illumination device 100 in the case of the configuration of the liquid crystal display apparatus, and reflects the component orthogonal to this. The reflected component that has not been transmitted through the polarization plate is diffused and reflected by the diffusion film 71, the diffusion plate 6 and the reflective sheet 4, so as to be unpolarized, and enters the polarization reflection sheet 73 again. The repetition of this allows the light having a uniform polarization direction to exit and to be transmitted through the liquid crystal panel. As a result, the efficiency of the liquid crystal display apparatus can be enhanced.

In a conventional edge light type backlight, a prism sheet, a diffusion sheet and the like are provided directly on a light guide plate. However, if the optical sheets are provided directly on the light guide plate 5 in the configuration in which the light sources 2 are provided inside the accommodating holes 50 of the light guide plate 5 and light does not exit from directly above the portions provided with the light sources, as is the case of the planar illumination device 100 of this embodiment, dark portions appear at the portions corresponding to the light sources, thus rendering uniform illumination impossible.

In the planar illumination device 100 of this embodiment, the optical sheets 7 are provided via the diffusion plate 6, thereby making it possible to eliminate or reduce the above-mentioned dark portions due to the lateral travelling effect of the diffusion plate 6.

In the configuration of the planar illumination device 100 of this embodiment, the diffusion plate 6 is added as a member, compared to the conventional edge light type backlight. Nevertheless, this does not necessarily cause an increase in thickness or an increase in weight of the device in the case of illumination for a large screen. When the conventional edge light type backlight is used for illuminating a large screen, high power LEDs are required to obtain a large amount of light for the aforementioned reasons, and thus a light guide plate is required to have an increased thickness (for example, about 5 mm) corresponding to an inevitable increase in the package size. In contrast, the configuration of this embodiment just requires the light source 2 to have a thickness that allows the light source 2 to encapsulate an LED chip (LED element) having a thickness of about 0.1 mm, regardless of the chip size, and therefore the thickness of the light guide plate 5 easily can be adjusted to about 2 mm or less. Even supposing that the diffusion plate 6 had a thickness of 2 mm, the total thickness of the diffusion plate 6 and the light guide plate 5 can be adjusted to about 4 mm or less, and thus can be adjusted to be equal to or less than the thickness of a light guide plate required for the edge light type.

It should be noted that when the size of the light source 2 is relatively large (for example, 2 times or more the thickness of the diffusion plate 6), the above-mentioned dark portions may not be eliminated with only the internal travelling function of the diffusion plate 6 in some cases. In such a case, a space d is provided between the light guide plate 5 and the diffusion plate 6 (FIG. 1 and FIG. 2 illustrate the case of providing the space d). This space d preferably has a height of at least ½ the maximum width w of the light source 2 as viewed from a direction orthogonal to the mounting surface 1a of the mounting substrate 1, in other words, at least ½ the maximum width of non-light exit section in the light exit surface 5a of the light guide plate 5. Here, the maximum width w of the light source 2 as viewed from a direction orthogonal to the mounting surface 1a means, for example, the length of one side in the case of the light source 2 having a square shape, or the length of a longer side in the case of the light source 2 having an elongated rectangular shape. For example, in the case of w=4 mm, the space d of 2 mm or more is enough. The light guide plate 5 and the diffusion plate 6 are held spaced from each other by a frame (not shown).

Even when providing the space d in this way, the thickness of the planar illumination device 100 can be reduced significantly since the height of the space d is definitely small compared to that of the interval that is required to be present between the light source and the diffusion plate in the conventional direct type.

Next, the output portions 5b and the shape of the accommodating hole 50 provided on the light guide plate 5 are described in detail. Before describing them, the unit section of the light guide plate 5 for defining them is described. The “unit section” means a section defined by a line composed of a sequence of points each having a distance from one light source equal to a distance from another light source adjacent to the one light source.

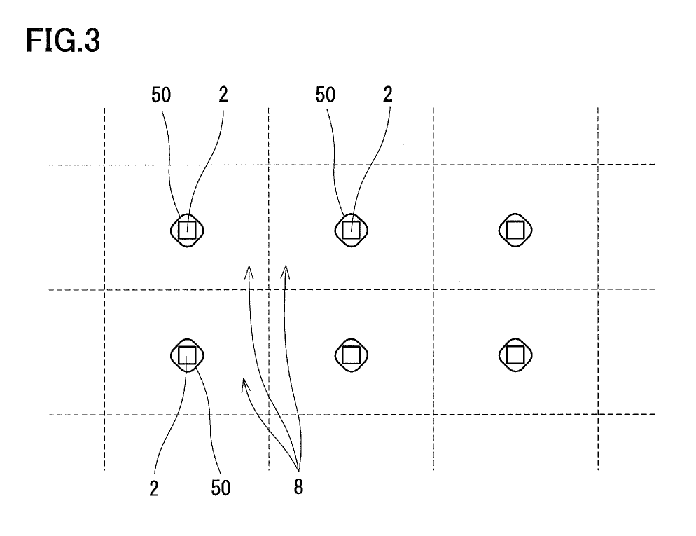

As mentioned above, the light sources 2 are arrayed in two directions orthogonal to each other and arranged on lattice points in this embodiment. Therefore, a unit section 8 that is provided for each light source 2 in the light guide plate 5 has a rectangular shape, as shown in FIG. 3.

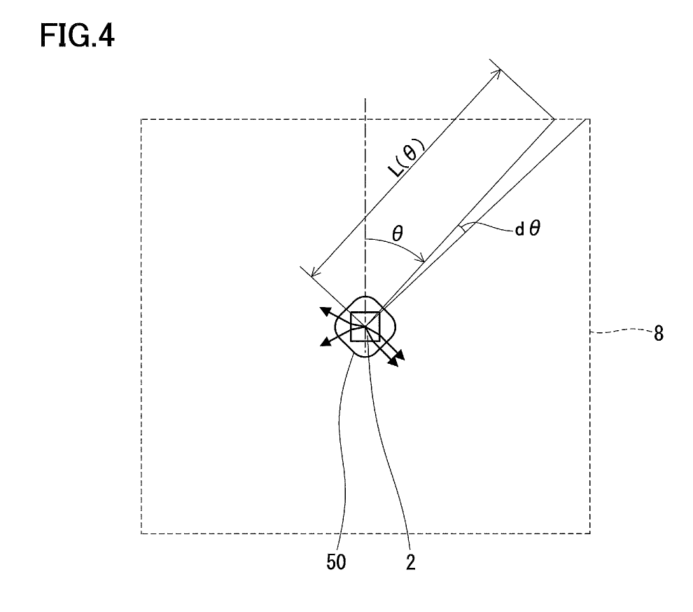

As shown in FIG. 4, each of the accommodating holes 50 has a shape corresponding to the shape of the light source 2 such that the light flux angular density dφ/dθ of the light that has been transmitted through the internal surface 50a of the accommodating hole 50, in the direction of the angle θ around the center of the light source 2 accommodated in the accommodating hole 50 as viewed from a direction orthogonal to the mounting surface 1a of the mounting substrate 1 (hereinafter, which may be simply referred to also as “viewed in plan”), increases toward each vertex of the unit section 8 that surrounds the light source 2 in the light guide plate 5. That is, the light flux angular density dφ/dθ is relatively large in the diagonal directions of the unit section 8, and is relatively small in the array directions of the light sources 2. It is preferable that the accommodating hole 50 have a shape such that the light flux angular density dφ/dθ increases quadratically toward each vertex of the unit section 8.

Here, supposing that a straight line extending from the center of the light source 2 in the θ direction is cut on the profile (outline) of the unit section 8 and the length of the line segment is taken as L (θ), the accommodating hole 50 preferably has a shape designed so that the light flux angular density dφ/dθ approximates the square of L(θ). It should be noted that the base line (θ=0°) of the angle θ may be oriented in any direction from the center of the light sources 2.

Specifically, each of the accommodating holes 50 projects toward the midpoint of each side of the unit section 8. In this embodiment, the light source 2 has the shape of a square with its sides being perpendicular to the array directions as viewed in plan, and therefore each of the accommodating holes 50 has a shape of a square that is slightly larger than the square of the light source 2 and that is rotated by 45 degrees therefrom with its corners being rounded. That is, the internal surface of the accommodating hole 50 that surrounds the resin portion 23, which has a quadrangular prism shape, of the light source 2 has a relatively large curvature (1/r) at the portions that face the four wall surfaces of the resin portion 23 and has a relatively small curvature at the portions that correspond to the corners of the resin portion 23.

Further, as shown in FIGS. 5 A and 5B, the output portions 5b preferably are patterned such that a concentration D, which is the ability to cause deviation from total reflection per unit area, increases as the distance from the center of the light source 2 to each of the output portions 5b increases, and each contour line (shown by the two-dot chain line in FIG. 5B) on which the concentration D is equal shows similarity to the shape of the unit section 8. The concentration D is determined from a moving radial length (X(θ)/L(θ)) that is obtained by normalizing a distance X (θ) from the center of the light source 2 by L (θ), independent of the angle θ. For example, the concentration D is the ratio of the area occupied by the output portions 5b on the other main surface of the light guide plate 5.

According to the above-described planar illumination device 100 of this embodiment, light from the light source 2 converges relatively more in the directions toward each vertex of the unit section 8 due to the shape of the accommodating hole 50 that is based on the shape of the light source 2. Therefore, the in-plane unevenness in brightness can be reduced.

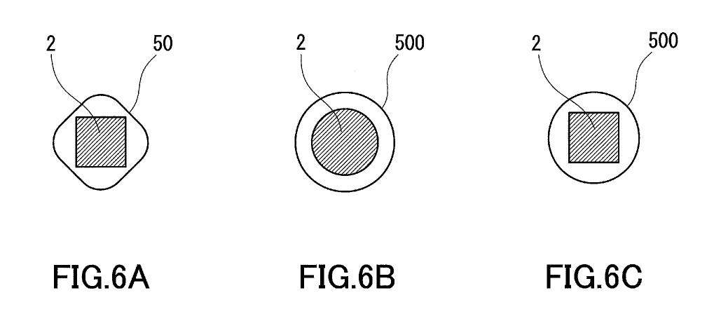

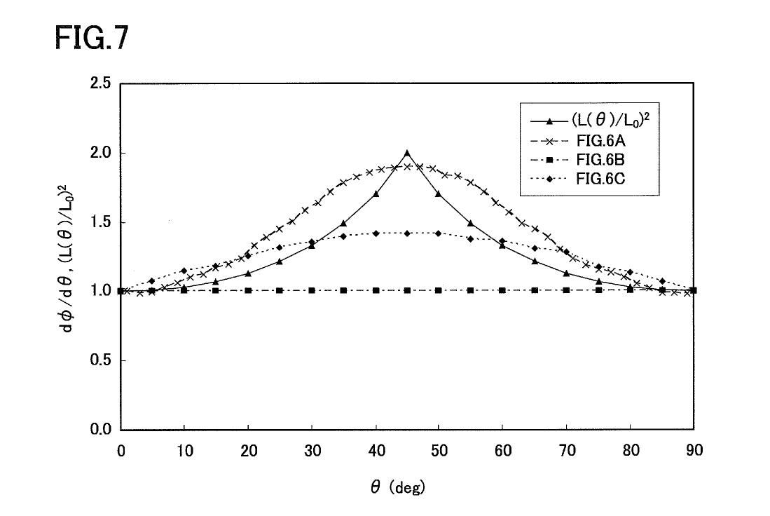

The results of the simulation that has been performed to confirm the effects of the planar illumination device 100 of this embodiment are described herein. In this simulation, three models shown in FIGS. 6A to 6C are prepared and arranged at the center of the unit section 8 in a square shape. The model of FIG. 6A is shown as this embodiment, in which the light source 2 has a square shape and the accommodating hole 50 has a rounded square shape. The model of FIG. 6B is shown as a comparative embodiment, in which the light source 2 in a circular shape is accommodated in an accommodating hole 500 in a circular shape. The model of FIG. 6C is shown as another embodiment, in which the light source 2 in a square shape is accommodated in the accommodating hole 500 in a circular shape. The direction of the angle θ being 0 degree is taken as the right upward direction of the center of the light source 2, and FIG. 7 indicates the light flux angular density dφ/dθ obtained in the simulation for the angle θ from 0 degree to 90 degrees. In FIG. 7, the light flux angular density dφ/dθ is normalized by the value of θ=0°. The light flux angular density dφ/dθ to be obtained for the angle θ from 90 degrees to 360 degrees is the repetition of the results in FIG. 7.

The required amount of light in the θ direction depends on the area of dθ in the unit section 8, and this area is proportional to the square of L (θ). The reference line ((L(θ)/L₀)²) shown by the solid line in FIG. 7 is obtained by normalizing the square of L (θ) by the value (L₀) of θ=0°. In order to reduce the in-plane unevenness in brightness, this reference line should be a target line of the light flux angular density dφ/d.

As shown in FIG. 7, in a comparative embodiment (FIG. 6B) in which the light source 2 has a circular shape and the accommodating hole 500 also has a circular shape, the light flux angular density dφ/dθ is constant whatever the value of the angle θ. Therefore, the amount of light is quite insufficient in the diagonal directions of the unit section 8. In contrast, as is the case of another embodiment, the light source 2 in a square shape (FIG. 6C) can improve this problem, thus making it possible to reduce the in-plane unevenness in brightness. However, in this case, the light flux angular density dφ/dθ forms a smooth convex line, which shows a slightly different tendency from the reference line. According to the configuration in this embodiment, it is possible to ensure a more sufficient amount of light in the diagonal directions of the unit section 8 because the light flux angular density dφ/dθ can approximate the reference line.

### Modified Embodiment

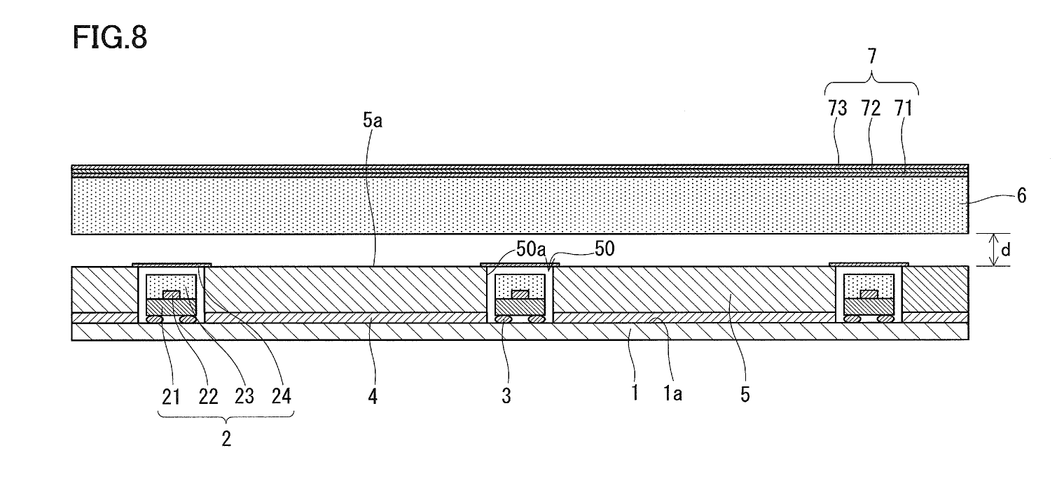

In the above-mentioned embodiment, the reflector 24 that serves to prevent light from the light source 2 from directly entering the diffusion plate 6 and thereby serves to allow the light to efficiently enter the light guide plate 5 is provided in close contact with the transparent resin 23. However, the present invention is not limited thereto. For example, as shown in FIG. 8, the reflector 24 may be provided separately from the resin portion 23. That is, the reflector 24 may be attached to the light exit surface 5a of the light guide plate 5 so as to cover each of the accommodating holes 50, and an air layer may be formed between the reflector 24 and the resin portion 23. In this case, highly uniform illumination can be expected by surely preventing light from leaking through the gap between the light source 2 and the incident surface 50a of the light guide plate 5.

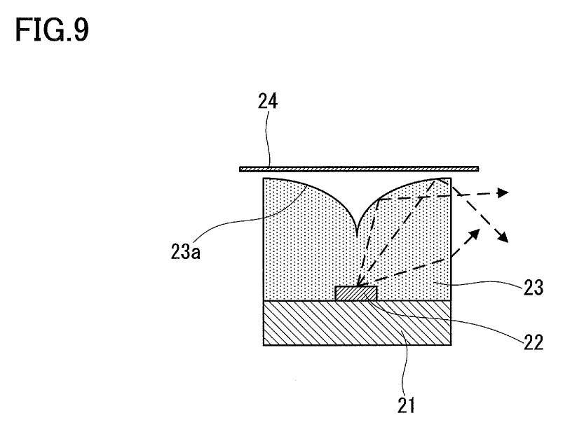

Further, as shown in FIG. 9, the surface of the resin portion 23 on the opposite side of the substrate 21 may serve as a total reflection surface 23a having a shape that totally reflects at least part of light from the LED element 22 in the radial direction over the entire circumference. This makes it possible to reduce light component to be absorbed while being reflected by the reflector 24 and thus enhance the efficiency. In this case, although it also is possible to omit the reflector 24, when the reflector 24 is provided, the reflector 24 can reflect the light that has been transmitted through the total reflection surface 23a as well, thereby allowing the light to enter the light guide plate 5.

Furthermore, the above-mentioned embodiment has a configuration in which the LED element 22 that emits blue light is employed and the yellow fluorescent material is dispersed in the resin portion 23. However, the present invention is not limited thereto. For example, a fluorescent material layer may be provided in the vicinity of the LED element 22 that emits blue light, and this may be encapsulated in a transparent resin. Further, green fluorescent material that converts blue light into green light and red fluorescent material that converts blue light into red light may be mixed for use instead of the yellow fluorescent material, or white light may be created using LED elements having three primary colors, RGB, that are mounted on the substrate 21.

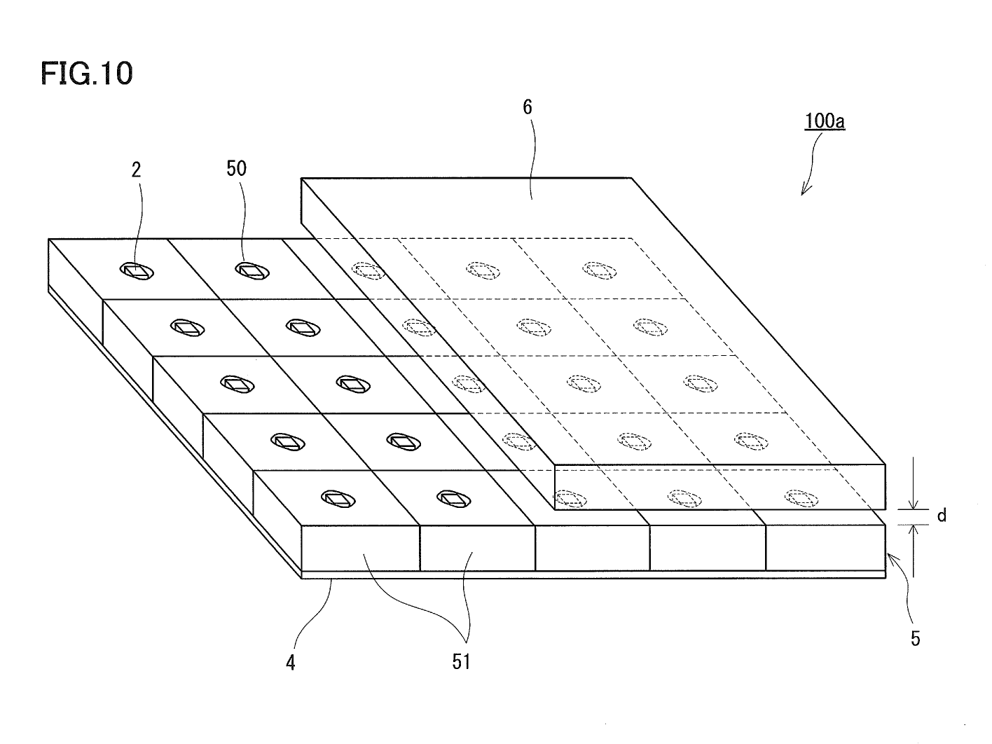

Further, although the light guide plate 5 is one continuous plate in the above-mentioned embodiment, the present invention is not limited thereto. For example, the light guide plate 5 may be divided into a plurality of light guide pieces 51 and may be constituted by these light guide pieces 51, as shown in FIG. 10. The light guide pieces 51 each preferably have at least one of the accommodating holes 50. Further, the light source 2 is provided inside the accommodating hole 50. Here, it is possible to clearly define each area unit that one light source 2 can illuminate by providing a reflective layer between the side surfaces that are a border of each adjacent two light guide pieces 51. This configuration is suitable, for example, for local area control. Further, it also is possible to select the size in view of productivity to minimize the total cost in mass production.

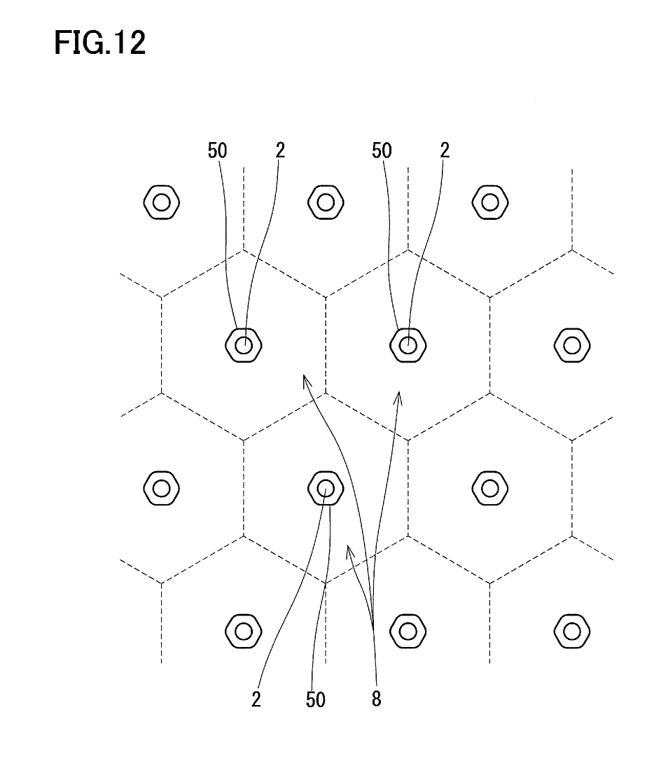

Further, the light sources 2 are provided on lattice points in the above-mentioned embodiment. However, the present invention is not limited thereto. For example, the light sources 2 may be arranged in two directions making an angle of 60 degrees at the same pitch in a staggered manner, as shown in FIG. 12. In this case, the unit section 8 has a regular hexagonal shape.

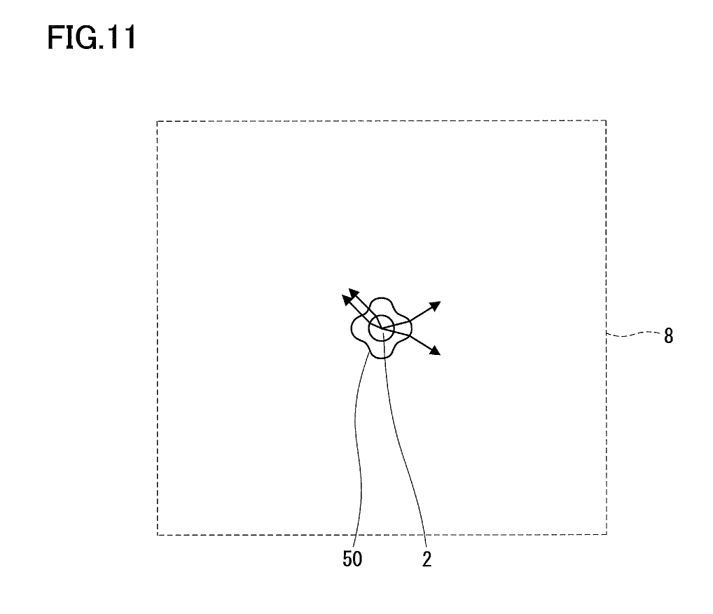

Furthermore, the shape of the accommodating hole 50 is not limited to a rounded square shape, and may be designed appropriately based on the shape and the arrangement of the light sources 2. For example, the accommodating hole 50 may have a cross star shape in the case where the light source 2 has a circular shape as viewed in plan, as shown in FIG. 11. Alternatively, the accommodating hole 50 may have a rounded hexagonal shape rotated by 60 degrees from the unit section 8, in the case where the light sources 2 in a circular shape as viewed in plan are arranged in a staggered manner, as shown in FIG. 12.

Further, the reflector 24 reflects all the incident light in the above-mentioned embodiment. However, the reflector 24 may have properties of reflecting most part of light from the LED element 22 and transmitting the rest of the light. This allows the light to exit from the portions provided with the accommodating holes 50 in the light guide plate 5 to the diffusion plate 6, thus making it possible to reduce further the unevenness of illumination. As described above, it is enough for the light source 2 to be capable of radiating light radially at least in a direction parallel to the mounting surface 1a, and the light source 2 may radiate light also in a direction perpendicular to the mounting surface 1a.

It is preferable that the transmittance of the reflector 24 be set appropriately in the range of about 0.1% to 2% depending on the size of the light source 2 or the percentage of light that travels upward. The ratio between light to be reflected and light to be transmitted can be adjusted by appropriately setting the thickness of the white PET sheet or the alumina substrate that forms the reflector 24, the ink concentration of the white pigment, the coating thickness thereof, or the thickness of the metal film.

### Embodiment 2

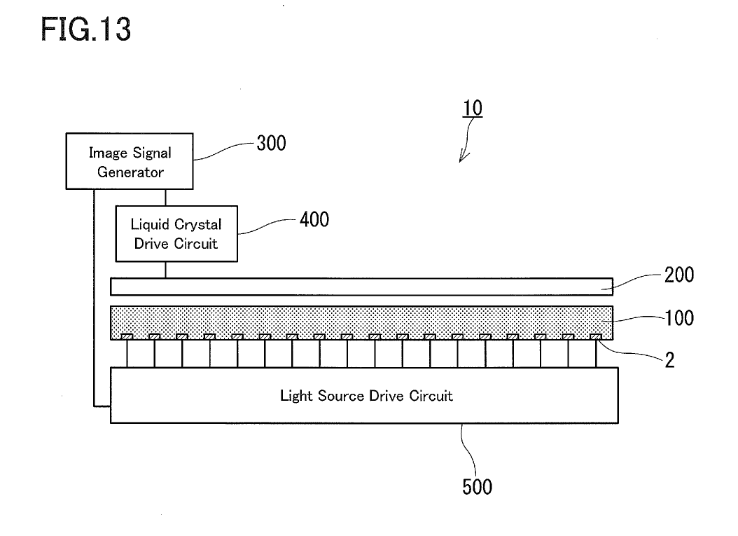

Next, Embodiment 2 of the present invention is described with reference to FIG. 13. FIG. 13 is a block diagram showing the configuration of a liquid crystal display apparatus 10 according to Embodiment 2 of the present invention.

The liquid crystal display apparatus 10 is provided with a backlight 100, a liquid crystal panel 200 provided on the light exit side of the backlight 100, an image signal generator 300, a liquid crystal drive circuit 400, and a light source drive circuit 500.

The backlight 100 in FIG. 13 is the planar illumination device 100 described in Embodiment 1. The light source drive circuit 500 that serves as a controller controls the luminescence intensity of a plurality of the light sources 2 provided on the same plane that are components of the backlight 100, for each specific area.

The liquid crystal drive circuit 400 controls the liquid crystal panel 200 in response to image signals from the image signal generator 300 and allows images to be generated. That is, the liquid crystal panel 200 displays images by spatially modulating light from the backlight 100 in response to image signals.

The light source drive circuit 500 controls the luminescence intensity of the light sources 3 for each control area in response to image signals from the image signal generator 300 so that portions corresponding to bright images should be illuminated brightly and portions corresponding to dark images should be illuminated dimly. Specifically, the light source drive circuit 500 changes the luminescence intensity of at least one light source selected from the light sources 2 in response to image signals. That is, the light source drive circuit 500 serves as a controller in the present invention.

The above-mentioned configuration makes it possible to enhance the quality of display by improving image contrast, and to reduce the consumption power required for illumination by decreasing the illumination of portions that are not required to be illuminated.

According to the liquid crystal display apparatus 10 of this embodiment, the light sources 2 are arranged planarly, so that a significant reduction in thickness of the apparatus is possible, while local area control can be achieved, compared to the case of using a conventional direct type backlight.

It should be noted that the descriptions above are to be considered as an exemplification of suitable embodiments of the present invention, and the scope of the present invention is not limited thereto. That is, the above-mentioned descriptions of the configuration and operation in use of the planar illumination device and liquid crystal display apparatus are just an example, and it is clear that various modifications and additions may be made to these examples without departing from the scope of the present invention.

### INDUSTRIAL APPLICABILITY

The planar illumination device and liquid crystal display apparatus of the present invention can contribute to reductions in thickness and weight, the improvement in display performance, and power savings, in liquid crystal display apparatuses such as a large screen-liquid crystal television or a liquid crystal monitor.

1. A planar illumination device comprising:
a plurality of light sources provided on a same plane, the light sources being capable of radiating light radially in a direction parallel to the plane;
a light guide plate having a plurality of accommodating holes that accommodate the plurality of the light sources separately, the light guide plate allowing the light that has been radiated from the plurality of the light sources and that has entered the inside of the light guide plate through internal surfaces of the plurality of the accommodating holes to exit from a light exit surface that is one main surface of the light guide plate; and
a diffusion plate provided facing the light exit surface of the light guide plate, wherein
each of the plurality of the accommodating holes has a shape corresponding to a shape of each of the plurality of the light sources such that a light flux angular density of the light that has been transmitted through the internal surface of the accommodating hole, in an angular direction around the center of the light source accommodated in the accommodating hole as viewed from a direction orthogonal to the plane, increases toward each vertex of a unit section that surrounds the light source in the light guide plate, and
the unit section is a section defined by a line composed of a sequence of points each having a distance from one light source equal to a distance from another light source adjacent to the one light source.

2. The planar illumination device according to claim 1, wherein
each of the plurality of the accommodating holes projects toward the midpoint of each side of the unit section.

3. The planar illumination device according to claim 1, wherein
the plurality of the light sources are arrayed in two different directions.

4. The planar illumination device according to claim 3, wherein
the plurality of the light sources are arrayed in two directions orthogonal to each other and arranged on lattice points so that the unit section has a rectangular shape, and
the light flux angular density is relatively large in diagonal directions of the unit section and is relatively small in array directions of the light sources.

5. The planar illumination device according to claim 4, wherein
each of the plurality of the light sources has a resin portion in a quadrangular prism shape that is made of a transparent resin and encapsulates an LED element, and
the internal surface of each of the plurality of the accommodating holes that surrounds the resin portion has a relatively large curvature at portions that face four wall surfaces of the resin portion and has a relatively small curvature at portions that correspond to corners of the resin portion.

6. The planar illumination device according to claim 1, wherein
a space having a height of at least ½ the maximum width of the light source, as viewed from a direction orthogonal to the plane, is provided between the light guide plate and the diffusion plate.

7. The planar illumination device according to claim 1, wherein
the light guide plate is constituted by a plurality of light guide pieces, and
each of the plurality of the light guide pieces has at least one of the plurality of the accommodating holes.

8. The planar illumination device according to claim 1, wherein
each of the plurality of the light sources includes a substrate, an LED element mounted on the substrate, and a resin portion that is made of a transparent resin and encapsulates the LED element.

9. The planar illumination device according to claim 8, wherein
each of the plurality of the light sources further includes a reflector provided on the opposite side of the substrate with respect to the resin portion.

10. The planar illumination device according to claim 9, wherein
the reflector has properties of reflecting major part of light from the LED element and transmitting the rest of the light.

11. The planar illumination device according to claim 9, wherein
the reflector is attached to the resin portion.

12. The planar illumination device according to claim 9, wherein
the reflector is attached to the light exit surface of the light guide plate so as to cover each of the plurality of the accommodating holes, and
an air layer is provided between the reflector and the resin portion.

13. The planar illumination device according to claim 8, wherein
the resin portion has a surface, on the opposite side of the substrate, having a shape that allows the surface to totally reflect at least part of light from the LED element.

14. The planar illumination device according to claim 1, wherein
the light guide plate has the other main surface provided with a plurality of output portions that reflect the light that has reached the other main surface so as to allow the light to be transmitted through the light exit surface, and
the plurality of the output portions are patterned such that a concentration that is the ability to cause deviation from total reflection per unit area increases as it gets farther from the center of the light source increases, and a contour line on which the concentration is equal shows similarity to the unit section.

15. A liquid crystal display apparatus comprising:
the planar illumination device according to claim 1; and
a liquid crystal panel provided on the light exit side of the planar illumination device, the liquid crystal panel being capable of displaying images by spatially modulating light from the planar illumination device in response to image signals.

16. The liquid crystal display apparatus according to claim 15, further comprising:
a controller capable of changing luminescence intensity of at least one light source selected from the plurality of the light sources, in response to image signals.
